(19) United States
(12) Patent Application Publication
(10) Pub. No.: US 2013/0091166 A1
(43) Pub. Date: Apr. 11, 2013

(54) METHOD AND APPARATUS FOR INDEXING INFORMATION USING AN EXTENDED LEXICON

(71) Applicant: Discovery Engine Corporation, San Francisco, CA (US)

(72) Inventors: Oscar B. Stiffelman, San Francisco, CA (US); Brian Basham, San Francisco, CA (US)

(73) Assignee: Discovery Engine Corporation, San Francisco, CA (US)

(21) Appl. No.: 13/646,141

(22) Filed: Oct. 5, 2012

Related U.S. Application Data
(60) Provisional application No. 61/544,024, filed on Oct. 6, 2011.

(51) Int. Cl. G06F 17/30

(52) U.S. Cl. 707/769; 707/E17.014

(57) ABSTRACT

A method and apparatus for indexing information using an extended lexicon. The method comprises receiving at least two search terms; accessing a first lexicon of posting list locations to determine a posting list location associated with at least one term in the at least two search terms; accessing an index, using the posting list location, wherein the index identifies a first posting list; accessing an extended lexicon of posting list locations to determine a posting list location associated with at least one of the at least two search terms found in the extended lexicon; accessing the index, using the posting list location associated with the at least one search term found in the extended lexicon, where the index identifies a second posting list for the at least one term found in the extended lexicon; and finding an intersection of documents identified by the first posting list and the second posting list as candidate search results related to the at least two search terms.

### CROSS-REFERENCE TO RELATED APPLICATIONS

This application claims priority to U.S. Provisional Patent Application Ser. No. 61/544,024 filed Oct. 6, 2011, which is incorporated by reference herein in its entirety.

### BACKGROUND OF THE INVENTION

1. Field of the Invention

Embodiments of the present invention generally relate to techniques used for indexing information accessible to search engines and, more particularly, to a method and apparatus for indexing information using an extended lexicon.

2. Description of the Related Art

The World Wide Web (commonly referred to as the “web” or the “Internet”) comprises a myriad of computers interconnected by a communications network. Each computer stores and presents a plurality of documents to users of the web. The process of searching the web comprises multiple steps divided into two phases: an off-line phase and an on-line phase. During the off-line phase, an index of keywords to documents stored on the web is created. During the on-line phase, this index is searched in order to produce results for a user-specified query.

The first step in the off-line phase acquires the documents to be searched. Typically, this step involves sending a large number of Hypertext Transfer Protocol (HTTP) requests to retrieve Hypertext Markup Language (HTML) documents from the web. Other data protocols, formats, and sources may also be utilized to acquire documents.

The second step in the off-line phase inverts any links between the documents acquired in the first step. A link represents a reference from a source document to a destination document. For example, most HTML documents on the web contain “anchor” tags that explicitly reference other documents by Universal Resource Locator (URL). During the link inversion step, links are collected by destination document instead of source. After link inversion is completed, each identified document contains a list of all other documents that reference it. The text from these incoming links (“anchortext”) provides an important source of annotation for a document. Note that the number of incoming links is unbounded, and often will greatly exceed the amount of text in the document itself.

A third step in the off-line phase enumerates a set of keywords or “terms” for each document. These terms represent the most important aspects of the document. The terms are generated from the document title, the on-page text, and the anchortext. A wide variety of techniques may be employed for selecting or filtering terms.

A fourth step in the off-line phase builds a lexicon of the terms generated in the third step. Each entry in the lexicon comprises a term and an associated “posting list”. The posting lists are organized into an index where the index entries include a posting list followed by a list of all documents containing the term of the posting list in addition to metadata associated with the documents and/or term. The metadata consists of the positions (offsets) of the term within a document, in the title of a document, and in the anchortext of a document. Additional metadata may include other document features, for example font size and color. Note that, because the amount of anchortext is unbounded, the amount of metadata in the posting list is also unbounded. As such, the lexicon and the index require a substantial amount of computer storage space.

A lexicon has a finite size, which limits the number of entries to important terms. Although some important terms may contain numbers, such as model numbers or other rare term occurrences, including such terms would make the lexicon excessively large and impractical to search using conventional techniques. As such, many important terms are not included in the lexicon.

Once all documents have been added to the index, the off-line phase is complete. The on-line phase, begins when a user submits a query to the search engine. A query is a sequence of terms.

The first step in the on-line phase parses the query. Typically, this step involves breaking the query into unigram terms. For example, the query new york restaurants is broken into the unigram terms: new, york, and restaurants. Additional query processing, such as removal of very common terms (e.g., a, the, an, and the like), may also be performed at this step. In general, a wide variety of algorithms and techniques may be employed to parse the query.

A second step in the on-line phase is posting list intersection. For each unigram term, the corresponding posting list is identified in the lexicon. In the example above, the posting lists for new, york, and restaurants (three separate lists) would be identified and then used to access documents/metadata in the index. A logical intersection is then performed on the retrieved information, thereby eliminating any document not present in every list. For example, a document that contains the word new but not the word york would be eliminated during intersection. All documents that survive the intersection are potential matches for the query.

A third step in the on-line phase reconstructs term matches. A term match is an instance of a query term matching a term in a document, its title, or anchortext. The positional information stored in the posting list metadata is used to determine if the term matches occur in close proximity to each other. For example, if the term new occurs at position 2, and the term york occurs at position 3, the system can reconstruct the contiguous phrase new york.

A fourth step in the on-line phase scores the documents that survived the intersection. A ranking function is employed to calculate the document scores. The ranking function takes as input all of a document's term matches and produces as output a single numerical value for the document. The ranking function is often a complex algorithm that transforms, normalizes, and combines its inputs. A wide variety of different functions and structures can be used for calculating document scores.

A final step in the on-line phase selects a subset of documents that survived the intersection based on the computed document scores. A variety of algorithms may be employed at this step. For example, filtering and sorting of documents based on scores. The selected subset of documents is then returned in part or entirely to the user as the search results. This marks the end of the on-line phase.

Therefore, there is a need for an improved web searching techniques.

### SUMMARY OF THE INVENTION

A method and apparatus for indexing information using an extended lexicon substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a computer system that utilizes at least one embodiment of the present invention;

FIG. 2 depicts a flow diagram of a method using an extended lexicon in accordance with at least one embodiment of the invention; and

FIG. 3 depicts a representative example of using the extended lexicon in accordance with at least one embodiment of the invention.

### DETAILED DESCRIPTION

Embodiments of the present invention comprise a method and apparatus for indexing information using an extended lexicon. The extended lexicon includes “additional slots” associated with posting lists related to rare terms. As described previously, a lexicon has a finite size, which limits the number of entries to important, that is, more frequently found, terms. As such, a term must occur with a frequency such that the term is contained in a predefined threshold number of documents in order for the term to be included in the lexicon. However, this will cause many important, but less frequently found terms, to be excluded from the lexicon

As such, references to these less frequently found terms are instead stored in an extended lexicon. When a document is indexed for a term that does not meet the threshold number of documents to be included in the lexicon, two hash values are created representing the term. Any hashing function may be used as long as they each form a unique and different hash value provided a single term. The document is added to the posting lists associated with each of the two hash values in the extended lexicon. Although each term results in two distinct hash values and therefore is associated with two posting lists, a single hash value may be associated with multiple terms. Because each posting list is based on a given hash value, each index associates many different terms to the same posting list, thereby minimizing the number of posting lists needed to index a large number of rare terms. Although each posting list is associated with many different terms, when the extended lexicon is searched, because the term is hashed twice, each time with a different hash function, an intersection of the posting lists for the two hash values returns relevant documents containing the rare term.

To access the extended lexicon, a term is first searched for in the conventional lexicon. If the term is not found in the conventional lexicon, the term is hashed using two different hashing algorithms to define two hash values for the term. The two hash values are then used to search the extended lexicon for a pair of posting lists. The posting lists are used in the index to find documents associated with the term. The intersection of the posting lists define a candidate set of documents.

The term “document” as used herein includes any form of content that can be found on the Internet as well as any metadata associated with such content and links to such content.

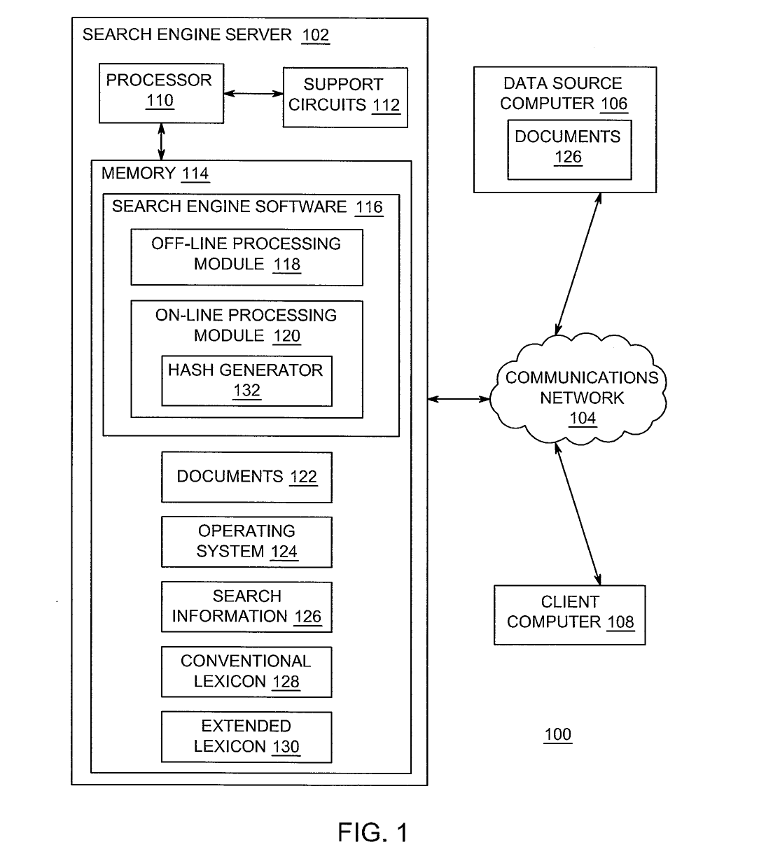

FIG. 1 depicts a block diagram of a computer system that utilizes at least one embodiment of the present invention. Embodiments of the present invention are implemented using a general-purpose computer programmed to operate as a specific purpose computer to perform the procedures described below. FIG. 1 depicts a computer system 100 comprising a search engine server 102, a communications network 104, data source computer 106 and at least one client computer (client 108). The system 100 enables a client 108 to interact with the search engine server 102 via the network 104, identify data (documents) at one or more data source computers 106 and display and/or retrieve the data from the data source computers 106.

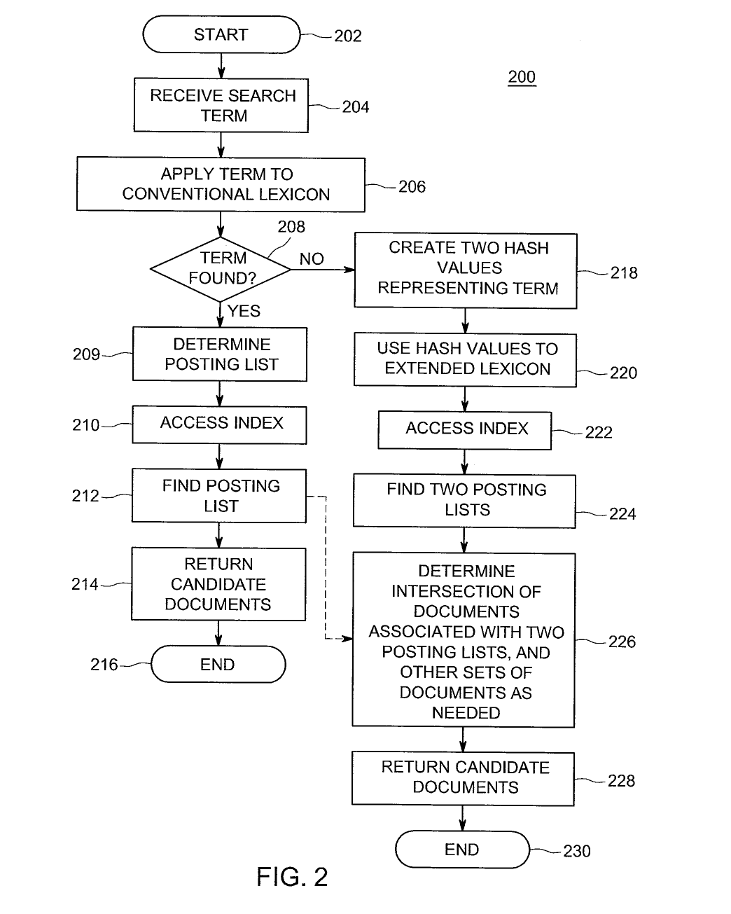

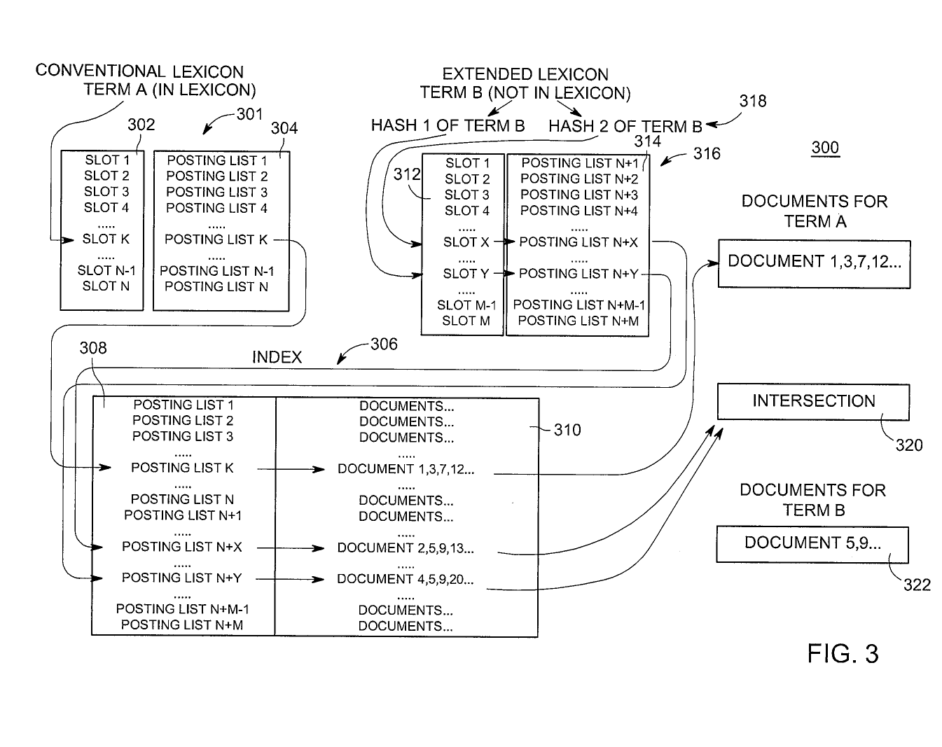

The search engine server 102 comprises a processor 110, support circuits 112 and memory 114. The processor 110 comprises one or more generally available microprocessors used to provide functionality to a computer server. The support circuits 112 support the operation of the processor 510. The support circuits 112 are well known circuits comprising, for example, communications circuits, input/output devices, cache, power supplies, clock circuits, and the like. The memory 114 comprises various forms of solid state, magnetic and optical memory used by a computer to store information and programs including but not limited to random access memory, read only memory, disk drives, optical drives and the like. The memory 114 stores search engine software 116, documents 122, conventional lexicon 128, extended lexicon 130, operating system 124 and search information 126. The operating system 124 may be one of many commercially available operating systems such as LINUX®, UNIX®, OSX®, WINDOWS® and the like. The documents 122 are typically stored in a database and are associated with posting lists. The search information 126 comprises posting lists, indices and other information created and used by the search engine software 116 to perform searching as described below with respect to FIGS. 2 and 3. The search engine software 116 comprises two main components relevant to the invention: off-line processing module 118 and on-line processing module 120. The on-line processing module 120 comprises two hash generators 132 that are used to access the extended lexicon 130 as described below. In some embodiments, the conventional lexicon 128 and the extended lexicon 130 are contained in a single file comprising a conventional lexicon portion and an extended lexicon portion of the file.

In operation, the search engine server 102 uses the off-line module 118 in a conventional manner to acquire documents 122 from the data source computers 106, create indices and other information (search information 126) related to the documents 122 (stored copies of documents 126). The client computer 108 using well-known browser technology sends a query to the search engine server. The search engine server uses the on-line processing module 120 to process the query and return to the client computer 108 for display results of a search that is responsive to the query. Embodiments of the invention utilize the extended lexicon to facilitate searching for documents related to search terms that are not contained in the conventional lexicon. When a search comprises one or more terms from the conventional lexicon 128 and one or more terms from the extended lexicon 130, the candidate search results are determined from an intersection of one or more posting lists associated with terms from the conventional lexicon 128 and one or more posting lists associated with terms from the extended lexicon 130.

FIG. 2 depicts a flow diagram of a method 200 using an extended lexicon in accordance with at least one embodiment of the invention. The method 200 represents one exemplary implementation of a portion of the on-line module or the search engine software. To assist in understanding the use of the extended lexicon, FIG. 3 depicts a representative example of the process flow 300 using an extended lexicon 316 in accordance with at least one embodiment of the invention. The reader should simultaneously refer to both FIGS. 2 and 3 in conjunction with the description below.

The method 200 begins at step 202 and proceeds to step 204 wherein the method 200 receives a search term from a client. The term comprises one or more components of a query such as a word or a combination of words. In FIG. 3, a term that will use a conventional lexicon 301 is TERM A and a term that will use the extended lexicon 316 is TERM B.

The method 200 proceeds to step 206, where, the term (either TERM A or TERM B) is applied to the conventional lexicon 301. The method 200 searches for a match between the received search term and the terms listed in the conventional lexicon. Each lexicon term is associated with a posting list. The method 200 proceeds to step 208, where the method 200 determines whether the term is found in a conventional lexicon. If the decision is negative, the method 200 proceeds to step 218 (e.g., to process TERM B). If the decision at step 208 is affirmative, the method 200 proceeds to step 209.

At step 209, the search term is processed in a conventional manner using the conventional lexicon 301. The conventional lexicon 301 comprises a table of terms (slots 1 through N at 302 in FIG. 3) associated with posting lists (lists 1 through N at 304 in FIG. 3). The method 200 determines, for example, a posting list (LIST K) associated with the search term (TERM A).

The method 200 proceeds to step 210, where the method 200 uses the posting list identified at step 209 to access the index 306. The index 306 is a table of posting lists 308 associated with the documents 310 that comprise the posting lists 308. The method 200 proceeds to step 212, where the method 200 identifies documents mapped to the posting list identified in step 210. For example, posting list K maps to documents 1, 3, 7 and 12 in the document list 310. The method 200 proceeds to step 214, where the method 200 returns the documents associated with the identified posting list. These documents become the search results to be sent to the client computer in response to the search query containing the search term. Once the documents are returned, the method 200 ends at step 216.

If, at step 208, the search term was not found in the conventional lexicon 301, the method 200 uses the extended lexicon 316 to find the search results. At step 218, the method 200 creates two hash values 318 representing the term (e.g., TERM B). Any hashing functions may be used as long as they each form a unique and different hash value provided a single term. The extended lexicon 316 comprises slots 312 (Slots 1 through M) associated with posting lists 314 (Lists N+1 through N+M). Each slot rather than being associated with a term, is associated with a hash value representing rare search terms. The extended lexicon is populated during the “off-line” phase when documents are added to the index. When a document is returned for a term that is not in the conventional lexicon, the term is hashed twice and the document is added to the posting lists associated with the two hash values.

The method 200 proceeds to step 220, where the method 200 applies the hash values 318 to the extended lexicon 316. The two hash values 318 identify two posting lists (e.g., Lists N+X and N+Y) within the extended lexicon 316. The method 200 proceeds to step 222, where the method 200 accesses the index 306. The method 200 proceeds to step 224, where the method 200 identifies the posting lists determined in the extended lexicon 316 within the index 306. These posting lists identify two sets of documents related to the search term (e.g., TERM B). In the example of FIG. 3, TERM B is mapped to a first posting list comprising documents 2, 5, 9 and 13. TERM B also maps to a second posting list comprising documents 4, 5, 9 and 20.

The method 200 proceeds to step 226, where the method 200 determines the intersection 320 of the documents associated with the two posting lists. In the example of FIG. 3, the intersecting documents are documents 5 and 9. If one or more search terms were found in the conventional lexicon and one or more search terms were not found in the conventional lexicon, meaning their hash values were found in the extended lexicon, then at step 226, the method 200 determines the intersection of the documents associated with the posting list(s) for the one or more search terms found in the conventional lexicon and the documents associated with posting lists for the hash values found in the extended lexicon.

The method 200 proceeds to step 228, where the method 200 returns the documents identified in the intersection as the candidate search results. The candidate search results will be scored and may be provided to the client that submitted the search query. The method 200 ends at step 230.

While the foregoing is directed to embodiments of the present invention, other and further embodiments of the invention may be devised without departing from the basic scope thereof, and the scope thereof is determined by the claims that follow.

1. A computer-implemented method of searching and accessing information comprising:
receiving at least two search terms;
accessing a first lexicon of posting list locations to determine a posting list location associated with at least one term in the at least two search terms;
accessing an index, using the posting list location, wherein the index identifies a first posting list;
accessing an extended lexicon of posting list locations to determine a posting list location associated with at least one of the at least two search terms found in the extended lexicon;
accessing the index, using the posting list location associated with the at least one search term found in the extended lexicon, where the index identifies a second posting list for the at least one term found in the extended lexicon; and
finding an intersection of documents identified by the first posting list and the second posting list as candidate search results related to the at least two search terms.

2. The method of claim 1, wherein the extended lexicon comprises a first hash value and a second hash value representing each of a plurality of rare terms not found in the first lexicon.

3. The method of claim 1, wherein the extended lexicon comprises a mapping of hash values to posting list locations.

4. The method of claim 1, wherein the posting list comprises at least one document and the location of the at least one document.

5. The method of claim 1, wherein the index comprises a plurality of posting list locations and at least one document comprising the at least one search term represented by the hash value, for each posting list location in the plurality of posting list locations.

6. A computer-implemented method of searching and accessing information comprising:
receiving at least one search term;
creating a first hash value and a second hash value representing the at least one search term;
accessing an extended lexicon of posting list locations to determine a posting list location associated with each of the first hash value and the second hash value;
accessing an index, using the posting list locations, wherein the index identifies a first posting list and a second posting list associated with the posting list locations; and
finding an intersection of documents identified by the first posting list and the second posting list as candidate search results related to the at least one search term.

7. The method of claim 6, wherein the extended lexicon comprises a mapping of hash values to posting list locations.

8. The method of claim 6, wherein the posting list comprises at least one document and the location of the at least one document.

9. The method of claim 6, wherein the index comprises a plurality of posting list locations and at least one document comprising the at least one search term represented by the hash value, for each posting list location in the plurality of posting list locations.

10. A computer-implemented method of searching and accessing information comprising:
receiving at least two search terms;
accessing a first lexicon of posting list locations to determine a posting list location associated with at least one term in the at least two search terms;
accessing an index, using the posting list location, where the index identifies a first posting list;
creating a first hash value and a second hash value representing at least one search term in the at least two search terms, wherein the at least one search term is not found in the first lexicon;
accessing an extended lexicon of posting list locations to determine a posting list location associated with each of the first hash value and the second hash value;
accessing the index, using the posting list location associated with the at least one search term not found in the first lexicon, wherein the index identifies a second posting list associated with the first hash value and a third posting list associated with the second hash value; and
finding an intersection of documents identified by the first posting list, the second posting list, and the third posting list as candidate search results related to the at least one search term.

11. The method of claim 10, wherein the first lexicon comprises a mapping of terms to posting list locations.

12. The method of claim 10, wherein the extended lexicon comprises a mapping of hash values to posting list locations.

13. The method of claim 10, wherein a hash value of the extended lexicon is not a representation of any term in the first lexicon.

14. The method of claim 10, wherein the first lexicon comprises terms that occur with a frequency such that the term occurs within a predefined threshold number of documents.

15. The method of claim 14, wherein the extended lexicon comprises hash values that represent terms that do not occur with a frequency that causes the term to be included in the first lexicon.

16. The method of claim 10, wherein the index comprises a plurality of posting list locations and at least one document comprising at least one of: the at least one search term represented by the hash value or the at least one search term, for each posting list location in the plurality of posting list locations.

17. A method for building an extended lexicon comprising:
receiving a term from a document;
determining the term is a rare term;
creating a first hash value and a second hash value representing the at least one term;
storing the first hash value and the second hash value in the extended lexicon with a first posting list associated with the first hash value and a second posting list associated with the second hash value; and
storing the document in an index wherein the index comprises a plurality of entries comprising the first posting list and the second posting and a plurality of documents associated with each of the posting lists.

18. The method of claim 17, wherein a term is a rare term when the term is contained in less than a predefined threshold number of documents.
